(19) United States
(12) Patent Application Publication
(10) Pub. No.: US 2013/0268464 A1
(43) Pub. Date: Oct. 10, 2013

(54) INTERNET-BASED MULTILEVEL MARKETING SYSTEM AND METHOD THEREOF

(71) Applicant: Chien-Lung Wen, Kaohsiung (TW)

(72) Inventor: Chien-Lung Wen, Kaohsiung (TW)

(21) Appl. No.: 13/440,220

(22) Filed: Apr. 5, 2012

(51) Int. Cl. G06Q 90/00

(52) U.S. Cl. 705/500

(57) ABSTRACT

A MLM recruitment method is provided with helping an originator to enlist participants as first-tier distributors; and requiring each first-tier distributor to buy an item of goods, finish one of the sub-steps of recruiting the participants as second-tier distributors in a first predetermined period of time so that the first-tier distributor become permanent members, and each second-tier distributor being required to recruit participants in the first predetermined period of time so that the second-tier distributor become permanent members; and requesting the originator to extend a second predetermined period of time to continue the recruitment if failing first sub-step and recruiting participants as the second-tier distributors in the second predetermined period of time so that the first-tier distributor become permanent members, and each second-tier distributor required to recruit sales people in a third predetermined period of time so that the second-tier distributors become permanent members; and create a distribution sub-organization.

### BACKGROUND OF THE INVENTION

1. Field of the Invention

The invention relates to multilevel marketing (MLM) and more particularly to an Internet-based multilevel marketing system and method thereof.

2. Description of Related Art

MLM is a marketing strategy in which the sales force is compensated not only for sales they personally generate, but also for the sales of others they recruit, creating a downline of distributors and a hierarchy multiple levels of compensation. Most commonly, the sales people are expected to sell products directly to consumers by means of relationship referrals and word of mouth marketing.

MLM companies have been a frequent subject of criticism as well as the target of lawsuits. Criticism has focused on high initial start-up costs, emphasis on recruitment of lower-tiered sales people over actual sales, encouraging if not requiring sales people to purchase and use the company's products, potential exploitation of personal relationships which are used as new sales and recruiting targets, and complex and sometimes exaggerated compensation schemes.

One problem facing MLM companies is that most participants lose money. And in turn, those participants do not have enthusiasm and devotion.

Thus, the need for an improved Internet-based multilevel marketing system still exists.

### SUMMARY OF THE INVENTION

It is therefore one object of the invention to provide a multilevel marketing (MLM) recruitment method comprising the steps of (a) helping an originator, already as a permanent member of an MLM organization, to enlist a plurality of participants as first-tier distributors for the originator; and (b) requiring each first-tier distributor to buy an item of goods from a specific company, finish one of the sub-steps of: (b1) recruiting the participants as second-tier distributors in a first predetermined period of time so that the first-tier distributors become permanent members of the MLM organization, and each of the second-tier distributors being required to recruit a plurality of participants in the first predetermined period of time so that the second-tier distributors become permanent members of the MLM organization; and (b2) requesting the originator to extend a second predetermined period of time to continue the recruitment if failing sub-step (b1) and subsequently recruiting a plurality of participants as the second-tier distributors in the second predetermined period of time so that the first-tier distributors become permanent members of the MLM organization, and each second-tier distributor being required to recruit a plurality of sales people in a third predetermined period of time equal to a deduction of the second predetermined period of time from the first predetermined period of time so that the second-tier distributors become permanent members of the MLM organization; and create a pyramid-like distribution sub-organization belonging to the MLM organization; and (c) associating each permanent member with at least one investment program over the Internet.

The above and other objects, features and advantages of the invention will become apparent from the following detailed description taken with the accompanying drawings.

### BRIEF DESCRIPTION OF THE DRAWINGS

FIG. 1 is a block diagram of an Internet-based multilevel marketing system according to the invention;

FIG. 2 schematically depicts a pyramid-like distribution organization of the invention;

FIG. 3A is a view similar to FIG. 2 showing the mechanism of eliminating an unqualified distributor;

FIG. 3B is a view similar to FIG. 3A showing the mechanism of using the substitute in place of the unqualified distributor; and

FIG. 4 is a table of profit distribution according to a preferred embodiment of the invention.

### DETAILED DESCRIPTION OF THE INVENTION

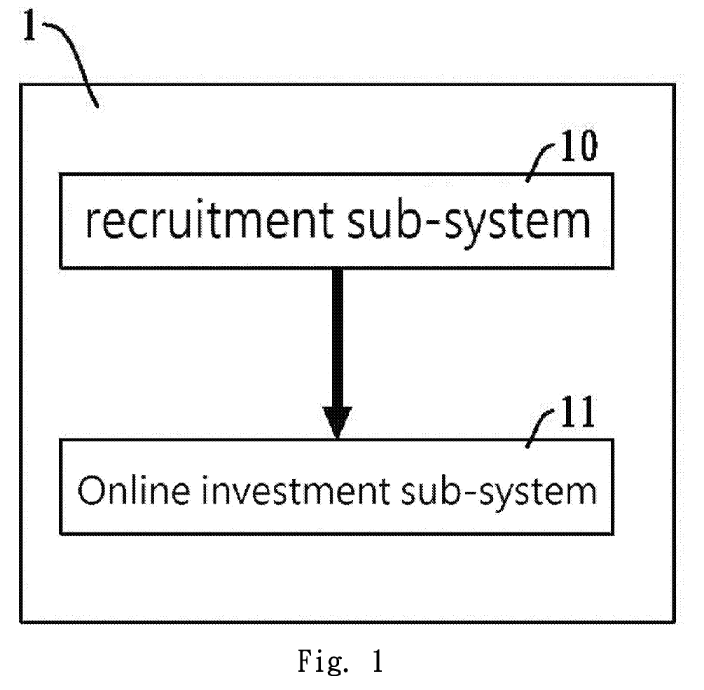

Referring to FIGS. 1 to 5, an Internet-based multilevel marketing (MLM) system 1 in accordance with the invention comprises the following components as discussed in detail below.

A recruitment sub-system 10 is provided to help an originator 21 to enlist a plurality of distributors 20 for his or her downline organization. The originator 21 is already a permanent member of the MLM system 1. Further, each distributor 20 (and each newly recruited member of his/her downline organization) is required to buy an item of goods from a specific company and finish one of the following jobs before becoming a permanent member of the MLM system 1:

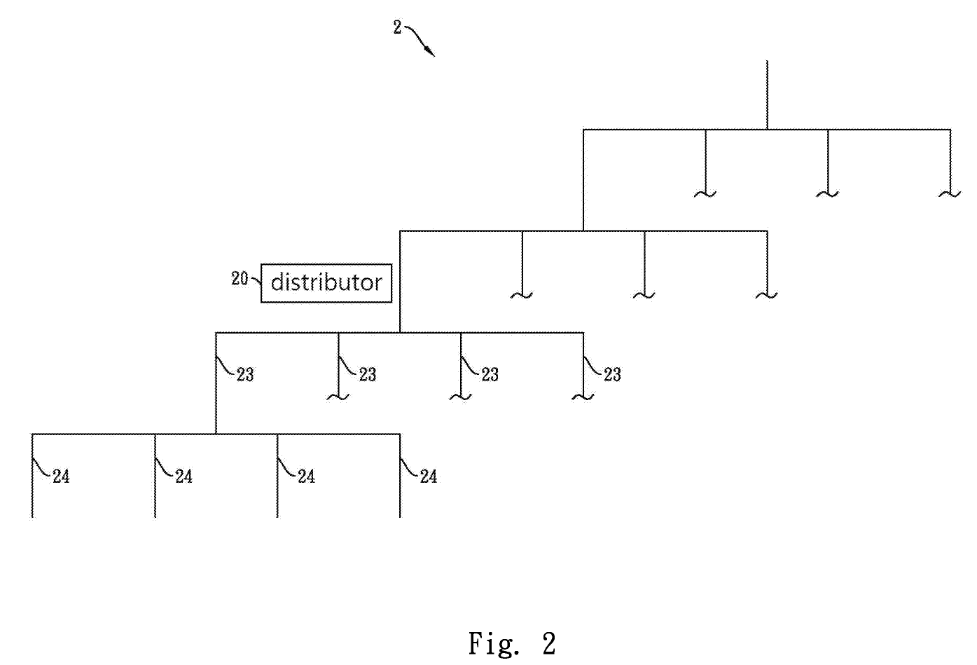

As shown in FIG. 2, each first-tier distributor 20 is required to recruit at least two sales people (four in this preferred embodiment) in a predetermined period of time (e.g., at least seven days and 30 days in the preferred embodiment). The distributor 20 is thus admitted as a permanent member of the MLM system 1. Thereafter, the four new members 23 belonging to the first-tier distributor 20 each are required to recruit four sales people 24 in 30 days before being admitted as a permanent member of the MLM system 1 and so on. As a result, a pyramid-like distribution organization 2 having 16-members is created.

Any first-tier distributor 20 is can request the originator 21 to extend at least five days (five days in the preferred embodiment) to continue the recruitment if he/she did not recruit the required number of new sales people (i.e., four new sales people) in 30 days. The first-tier distributor 20 can be admitted as a permanent member of the MLM system 1 if he/she achieves the required recruitment. Thereafter, the four new members 23 belonging to the first-tier distributor 20 each are required to recruit four sales people 24 in 25 days (i.e., 5 deducted from 30) before being admitted as a permanent member of the MLM system 1 and so on. As a result, a pyramid-like distribution organization 2 having 16-members is created.

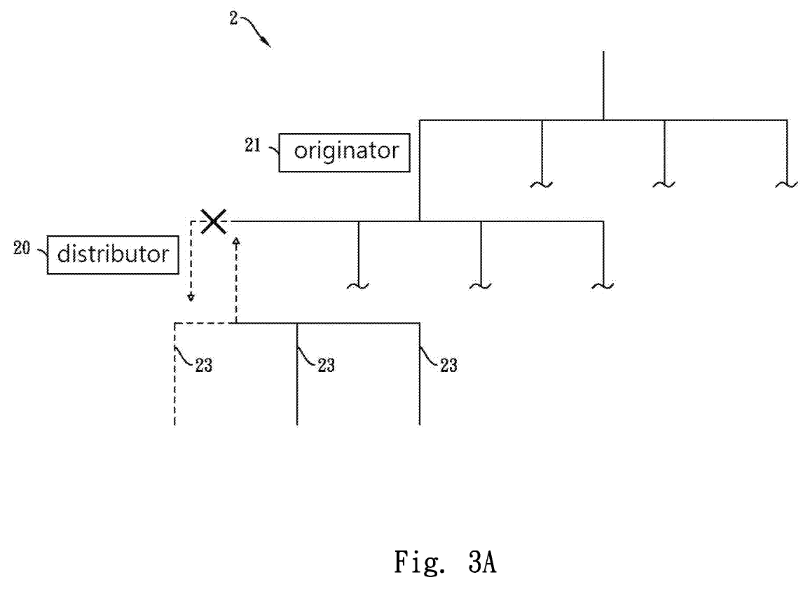

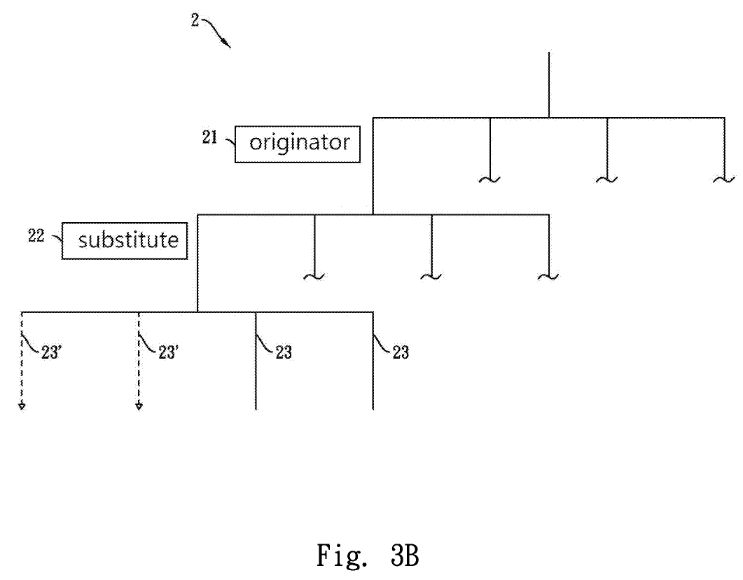

The first-tier distributor 20 is eliminated from the MLM system 1 (i.e., the pyramid-like distribution organization 2) if he/she did not recruit the required number of new sales people within the five-day extension. As shown in FIG. 3A, the first-tier distributor 20 recruited only three new sales people. Thereafter, the three new sales people previously belonging to the eliminated first-tier distributor 20 temporarily belong to the originator 21.

Thereafter, the originator 21 appoints a substitute 22 in place of the unqualified first-tier distributor 20 (see FIG. 3B). The substitute 22 is required to recruit the required four sales people (i.e., one new sales people 23′, one status changed sales people 23′, and two old sales people 23) in 30 days before being admitted as a permanent member of the MLM system 1. Thereafter, the four new members 23′, 23 belonging to the substitute 22 each are required to recruit four sales people in 30 days before being admitted as a permanent member of the MLM system 1 and so on. As a result, a pyramid-like distribution organization 2 having 16-members is created.

Members of the pyramid-like distribution organization 2 can be exponentially expanded in the order of the number of the first-tier distributors by following rules stated in above three paragraphs. Each of the originator 21, the distributor 20, and the substitute 22 can be rewarded with a predetermined percentage of commission after forming the pyramid-like distribution organization 2 (i.e., a 16-member organization as a minimum requirement). In brief, each permanent member can make a predetermined amount of money.

The eliminated first-tier distributor 20 can be admitted to the MLM system 1 again by fulfilling the following requirements:

The eliminated first-tier distributor 20 recruits the required four sales people 23 and each sales people 23 subsequently recruits four sales people 24. Thus, a pyramid-like distribution organization 2 having 16-members is created with the first-tier distributor 20 and the second-tier sales people 23 becoming permanent members of the MLM system 1. The first-tier distributor 20 is thus permitted to reenter the MLM system 1 by owning his/her pyramid-like distribution organization 2.

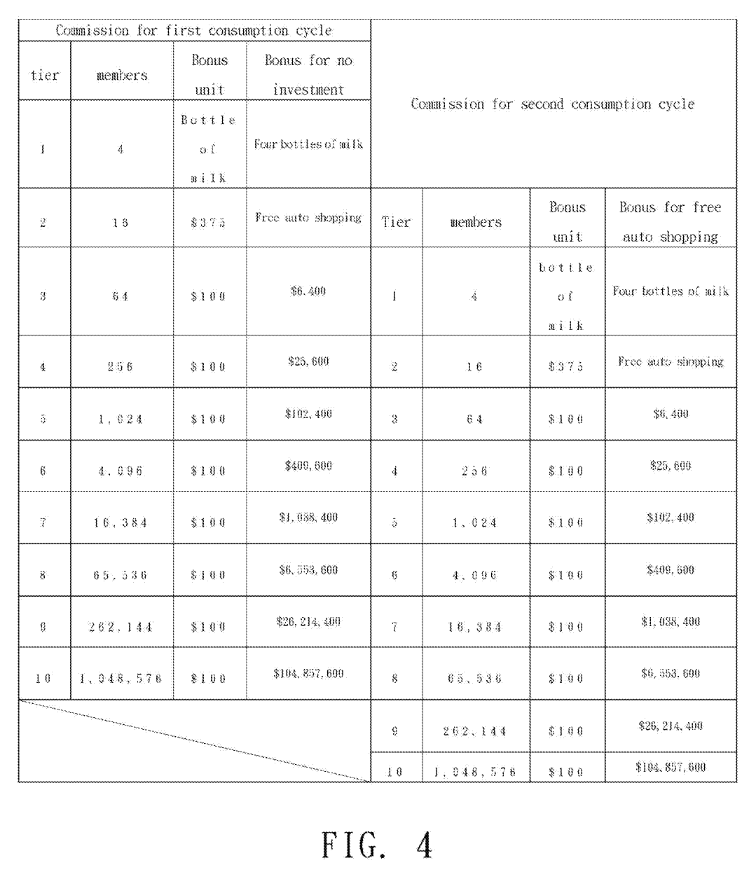

An online investment sub-system 11 functions to associate each permanent member with at least one investment program. Further, each permanent member can earn a profit from the investment program if the investment program makes money. That is, one initial buying is required for each sales people whenever he/she is in the organization and is rewarded with unlimited profit subject to the associated investment program making money. The profit of entering the organization is tabulated in an exemplary table shown in FIG. 4. It is envisaged by the invention that any permanent member of the MLM system 1 can expect a stable income.

While the invention has been described in terms of preferred embodiments, those skilled in the art will recognize that the invention can be practiced with modifications within the spirit and scope of the appended claims.

What is claimed is:

1. A multilevel marketing (MLM) recruitment method comprising the steps of:
(a) helping an originator, already as a permanent member of an MLM organization, to enlist a plurality of participants as first-tier distributors for the originator; and
(b) requiring each first-tier distributor to buy an item of goods from a specific company, finish one of the sub-steps of:
(b1) recruiting the participants as second-tier distributors in a first predetermined period of time so that the first-tier distributors become permanent members of the MLM organization, and each of the second-tier distributors being required to recruit a plurality of participants in the first predetermined period of time so that the second-tier distributors become permanent members of the MLM organization; and
(b2) requesting the originator to extend a second predetermined period of time to continue the recruitment if failing sub-step (b1) and subsequently recruiting a plurality of participants as the second-tier distributors in the second predetermined period of time so that the first-tier distributors become permanent members of the MLM organization, and each second-tier distributor being required to recruit a plurality of sales people in a third predetermined period of time equal to a deduction of the second predetermined period of time from the first predetermined period of time so that the second-tier distributors become permanent members of the MLM organization; and
create a pyramid-like distribution sub-organization belonging to the MLM organization; and
(c) associating each permanent member with at least one investment program over the Internet.

2. The multilevel marketing system of claim 1, further comprising the steps of (d) eliminating the first-tier distributors from the MLM organization if failing sub-steps (b1) and (b2), (e) assigning any second-tier distributor associated with the eliminated first-tier distributor to the originator, (f) appointing a substitute in place of the eliminated first-tier distributor, and (g) requiring the substitute to recruit a plurality of participants as the second-tier distributors in the second predetermined period of time so that the substitute becomes a permanent member of the MLM organization.

3. The multilevel marketing system of claim 1, wherein the first predetermined period of time is at least 7 days.

4. The multilevel marketing system of claim 1, wherein the second predetermined period of time is at least 5 days and less than the first predetermined period of time.

5. The multilevel marketing system of claim 4, wherein the plurality of participants as either the first-tier or second-tier distributors comprise at least 2 participants.

6. The multilevel marketing system of claim 2, further comprising admitting the eliminated first-tier distributor to the MLM organization if the eliminated first-tier distributor achieves sub-steps (b1) and (b2).

7. The multilevel marketing system of claim 1, wherein each permanent member is given a predetermined percent commission.
